(19) United States
(12) Patent Application Publication
(10) Pub. No.: US 2011/0306261 A1
(43) Pub. Date: Dec. 15, 2011

(54) METHOD FOR PRODUCING FLEXIBLE METAL CONTACTS

(75) Inventor: Frank Haaß, Erzhausen (DE)

(73) Assignee: BASF SE, LUDWIGSHAFEN (DE)

(21) Appl. No.: 13/203,407

(22) PCT Filed: Feb. 22, 2010
(86) PCT No.: PCT/EP10/52194

§ 371 Date: Aug. 25, 2011

(30) Foreign Application Priority Data
Feb. 25, 2009 (EP) 09153561.7

(51) Int. Cl. D04H 13/00; B23P 17/04; H01R 43/16

(52) U.S. Cl. 442/377; 29/874; 72/206

(57) ABSTRACT

To produce flexible electrical and/or thermal metal contacts for connecting electrical, electronic or thermal components, metal fibers, metal fiber nonwovens or metal fiber wovens with an average fiber diameter in the range from 1 to 500 μm are compacted by rolling, pressing or extruding involving cold working to form fibrous sheets.

The invention relates to a method for producing flexible electrical and/or thermal metal contacts for connecting electrical, electronic or thermal components, to such contacts and to the use thereof to compensate for mechanical and/or thermal stresses in an electrical, electronic or thermal component.

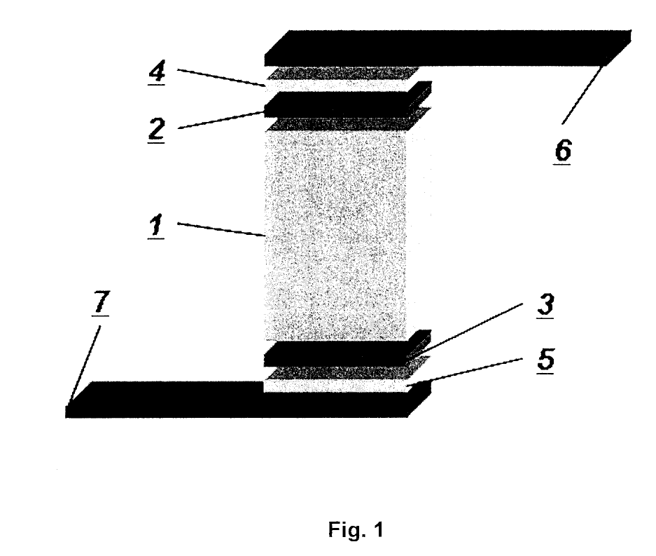

An essential element of electrical, electronic and thermal components is the contacting. The contacting represents the physical connection between the material at the “heart” of the component (that is responsible for the desired effect of the component) and the “outside world”. The specific structure of such a contact is schematically represented in FIG. 1.

The material 1 within the component provides the actual effect of the component. This may be, for example, an electrical resistor, a diode material, a capacitor, a piezo crystal, or a thermoelectric leg. Reference to the material is not intended to imply any restriction to a single material at this point, since it may well be that a number of materials, composites or other “structural units” are concerned. What is relevant, including for the purposes of the invention, is that the material 1 must be flowed through by an electric current and/or heat in order to perform its purpose in the overall structure.

Precisely this coupling of the electric current and/or flow of heat can prove to be a limiting factor for the performance characteristics of the component. A conventional structure is shown in FIG. 1. The material 1 is connected on at least two sides by way of the contacts 4 and 5 to the leads 6 and 7, respectively. The layers 2 and 3 are intended in this case to symbolize a possibly necessary intermediate layer (barrier material, solder, adhesion promoter or the like) between the material 1 and the contacts 4 and 5. However, these intermediate layers may well also be omitted or comprise multiple layers, depending on the specific structure of the component. The respectively paired segments 2/3, 4/5, 6/7 may be identical, but do not have to be. This likewise depends ultimately on the specific structure and the application, as well as on the direction of flow of electric current or heat through the structure.

So the important function is performed by the contacts 4 and 5. They provide a close connection between material and lead. If the contacts are poor, high losses occur here, possibly greatly restricting the performance of the component. For this reason, the contacts are often also pressed onto the material. The contacts are therefore exposed to strong mechanical loading. This mechanical loading also increases as soon as increased (or decreased) temperatures and/or thermal changes come into play. The thermal expansion of the materials incorporated in the component unavoidably leads to mechanical stress, which in an extreme case can lead to failure of the component as a result of the contact breaking off.

To prevent this, the contacts used must have a certain flexibility and resilient properties, in order to allow compensation for such thermal stresses.

A metal sheet or small metal plate is normally not soft or flexible enough to meet the requirements.

In the case of thermoelectric structural elements that are operated in a sometimes quite large temperature gradient (several hundred kelvins), the use of such “buffering” contacts is known from the literature. For instance, N. Elsner, Mat. Res. Soc. Symp. Proc. 1991, 234, 167, describes the use of flexible metal plates for contacting in thermoelectric generators.

The contacts described are still not adequately flexible and adaptable under strong temperature variations for all applications.

It is an object of the present invention to provide a method for producing flexible electrical and/or thermal metal contacts for connecting electrical, electronic or thermal components that leads to flexible or resilient contacts that have an advantageous range of properties, in particular for thermoelectric applications.

The object is achieved according to the invention by a method for producing flexible electrical and/or thermal metal contacts for connecting electrical, electronic or thermal components in which metal fibers, metal fiber nonwovens or metal fiber wovens with an average fiber diameter in the range from 1 to 500 μm are compacted by rolling, pressing or extruding involving cold working to form fibrous sheets.

It has now been found that rolling, pressing or extruding fine wire meshes, wire wovens or nonwovens can produce very dense fibrous sheets, which have high thermal and electrical conductivity in the component and in addition are mechanically very stable, but at the same time soft (that is to say compliant to pressure or resilient) and flexible enough to compensate for thermal and mechanical stresses.

At the same time, different metals can be used according to the intended application. Classic contacting metals such as copper, silver, gold, aluminum, iron or steels are of course particularly preferred, but in principle the method can be used for any metallically conductive material. According to one embodiment of the invention, the metal is Cu, Ag, Au, Fe, Ni, Pt, Al or alloys thereof.

In the metal fibers, metal nonwovens or metal fiber wovens, the average fiber diameter is 1 to 500 μm, preferably 10 to 100 μm, in particular 40 to 80 μm. Metal wovens are also understood as including metal knits. The metal nonwovens preferably have a greater extent in two spatial directions than in the third spatial direction, so that they are sheet-like nonwovens. Metal wovens preferably have a weight per unit area of 100 to 5000 g/m², particularly preferably 160 to 2800 g/m², in particular 1400 to 2000 g/m². The metal contacts to be produced preferably have an average diameter or a thickness in the range from 100 μm to 10 mm.

Structured or unstructured (in the sense of the direction of the fibers) wovens or nonwovens may be used as starting materials. The density of the woven fabric has an influence on the result of course, but in principle there are no restrictions here regarding mesh width, surface density or the like.

The length of the fiber itself may also be varied within wide limits, as long as the woven fabric holds together.

There is also no restriction in terms of the nature of the surface of the individual fibers. Although a rough surface of the fibers quickly leads to dense interlocking in the product, a nonwoven or woven made up of smooth fibers can also be processed and compacted without any problem.

The metal fiber wovens or metal fiber nonwovens may be folded one or more times before compaction, to form thicker nonwoven or woven coverings. Metal fiber wovens or metal fiber nonwovens of different metals may also be combined to form a laminated composite. Wovens or nonwovens with different alignment may also be laid one on top of the other. Generally, nonwovens and wovens have one or two preferential directions. Layers laid one on top of the other or following one another may in this case have the same preferential direction, or the preferential directions in the individual layers may form an angle to one another. For example, a unidirectional metal fiber nonwoven may be laid alternately in the longitudinal and transverse directions, one nonwoven on top of the other.

The production process itself is preferably based on a metal fiber nonwoven. This may, for example, be used directly for the compaction. However, it is also possible to fold the nonwoven a number of times before compaction (like a newspaper), and then compact it. In this way, thicker and closely interlocked contact plates are obtained. In principle, it is also possible to carry out folding only after a first compaction step and then to perform compaction once again (and repeat the operation a number of times if need be), but, owing to the smoother surface of the material once compacted, this normally leads to poorer interlocking of these individual layers.

Since the compaction is a directional operation, at least in the case of the preferred rolling or extrusion (forcing through a die), the orientation of the workpiece ultimately also plays a part here, especially since the nonwoven itself of course sometimes also has a preferential orientation of the fibers. Successive “crosswise” compaction in two spatial directions that are perpendicular to each other therefore appears to be the most favorable for close and dense interlocking.

The rolling may be performed in a single rolling device, or else by using a number of rolls used in parallel or in series. The rolls may in this case both have a smooth surface and have a structured surface. The latter may be of advantage if a certain surface roughness is desired in the product.

In the case of extrusion, for example of the nonwoven, the form of the extrusion die is of primary importance of course. Extrusion is particularly useful if a specific geometry of the product is required, or if uniaxial compaction is not desired or not adequate.

Cold working may, if appropriate, be combined with heating or cooling, in order to adapt the processing properties of the respective metals to the respective rolling, pressing or extruding method, depending on the fiber thickness.

In addition, the methods may be used for continuous and discontinuous production.

The invention also relates to flexible electrical and/or thermal metal contacts comprising fibrous sheets, obtainable by the method described above.

These metal contacts are preferably used to compensate for mechanical and/or thermal stresses in an electrical, electronic or thermal component. Compensated for in particular in this case are the mechanical and/or thermal stresses that can occur under operating conditions.

The fibrous sheets or metal contacts may be used in a large number of applications in which good thermal and/or electrical conductivity is important. Preferred application areas are thermoelectrics, magnetocalorics, electronic components such as capacitors, fuel cells, transformers, batteries, electric generators, photovoltaics or system combinations thereof. It is particularly preferred for the component to be a thermoelectric generator or a Peltier element.

The invention is explained in more detail by the following example.

### Example 1

A copper nonwoven with a wire thickness of 60 μm was transformed into a fibrous sheet by rolling. In this case, the material was compacted from a starting thickness of 4.5 mm to 0.9 mm.

### Example 2

A copper woven with a fiber diameter of 60 μm and a weight per unit area of 1700 g/m² was transformed into a fibrous sheet by rolling. In this case, the material was compacted from a starting thickness of 6.0 mm to 1.4 mm.

1-10. (canceled)

11. A method for producing at least one flexible metal contact, the method comprising:
compacting at least one metal fiber nonwoven with an average fiber diameter in a range from 1 to 500 μm by rolling; and
cold working to form at least one fibrous sheet,
wherein the flexible metal contact is at least one selected from the group consisting of an electrical metal contact and a thermal metal contact, and
wherein the at least one metal contact is suitable metal contact for connecting an electrical, electronic, or thermal component.

12. The method of claim 11, wherein the average fiber diameter of the nonwoven is 10 to 100 μm.

13. The method of claim 11, wherein a metal of the nonwoven comprises at least one selected from the group consisting of Cu, Ag , Au, Fe, Ni, Pt, and Al.

14. The method of claim 11, wherein the at least one metal contact has an average diameter or a thickness in a range from 100 μm to 10 μm.

15. The method of claim 1, wherein the at least one metal fiber nonwoven is folded at least one time before compaction, to form at least one thicker nonwoven covering.

16. The method of claim 11, wherein metal fiber nonwovens of at least two different metals are laid one on top of the other, to obtain a composite, and the composite is compacted.

17. The method of claim 1, wherein the compacting is performed successively in two spatial directions that are perpendicular to each other.

18. A flexible metal contact, comprising at least one fibrous sheet, obtained by the method of claim 1,
wherein the contact is at least one selected from the group consisting of a flexible electrical metal contact and a flexible thermal metal contact.

19. The method of claim 11, wherein average fiber diameter of the nonwoven is 10 μm to 80 μm.

20. The method of claim 11, wherein average fiber diameter of the nonwoven is 40 μm to 80 μm.

21. The method of claim 11, wherein a metal of the nonwoven comprises Cu.

22. The method of claim 11, wherein a metal of the nonwoven comprises Ag.

23. The method of claim 11, wherein a metal of the nonwoven comprises Au.

24. The method of claim 11, wherein a metal of the nonwoven comprises Fe.

25. The method of claim 11, wherein a metal of the nonwoven comprises Ni.

26. The method of claim 11, wherein a metal of the nonwoven comprises Pt.

27. The method of claim 11, wherein a metal of the nonwoven comprises Al.

28. The method of claim 11, wherein the flexible metal contact is a flexible electrical metal contact.

29. The method of claim 11, wherein the flexible metal contact is a flexible thermal metal contact.

30. The method of claim 11, wherein the flexible metal contact is a flexible electrical and thermal metal contact.
